(19) United States
(12) Patent Application Publication
(10) Pub. No.: US 2024/0046811 A1
(43) Pub. Date: Feb. 8, 2024

(54) A HYPER-PERSONALIZED INTERACTIVE LEARNING SYSTEM AND ITS METHOD OF OPERATION THEREOF

(71) Applicant: AXOSPARK TECHNOLOGIES PRIVATE LIMITED, Noida, Uttar Pradesh (IN)

(72) Inventor: Sandeep PAGEY, Noida, Uttar Pradesh (IN)

(21) Appl. No.: 18/038,469

(22) PCT Filed: Dec. 6, 2021
(86) PCT No.: PCT/IB2021/061357

§ 371 Date: May 24, 2023

(30) Foreign Application Priority Data
Dec. 15, 2020 (IN) 202011054554

(51) Int. Cl. G09B 7/04

(52) U.S. Cl. CPC G09B 7/04

(57) ABSTRACT

The present invention relates to a method and system that facilitates online education system providing specialized, customized, or content specific problem solving. The present invention relates to a complete learning system with at least three integrated components—learning, assessment and revision, each component being hyper-personalized to the finest level. The learning system does not use pre-recorded videos but instead generates audio-visual explanations, thereby allowing any problem to be solved and allowing every explanation to be hyper-personalized in terms of pace and content.

### FIELD OF INVENTION

The present invention relates to system and method for advanced learning. Particularly, the present invention discloses a method and system that facilitates learning system providing specialized, customized, or content specific problem resolution.

### BACKGROUND OF THE INVENTION

It is a well-known fact that not everybody learns in the same manner. Some people learn better visually, others learn better audibly, and yet others learn better through participation in exercises that require the person to do or perform some activity. Therefore, teachers apply plurality of techniques to improvise the learning habits and improve the learning of the students based on their ability to learn.

Traditional Technology-Enhanced Learning (TEL) systems offer very few strategies for the personalization of educational offerings. This limits the scope for providing effective TEL experiences to students. Recent developments in technology, coupled with the growing availability of low-cost or no-cost educational materials of high quality (e.g., open content) have made it possible to develop powerful, yet potentially widely available technology enhanced learning environments (TELE). Growing enhancements are providing supportive and instructional system to students. The TEL environments deliver instructional content and provide a platform designed to support student learning.

Adaptive educational hypermedia systems (AEHS) have been developed to address learner dissatisfaction by attempting to personalize the learning experience. This adaptivity is based upon various characteristics of the learner, including knowledge level, goals, or motivation. The purpose of such adaptive educational offerings is to maximize learner satisfaction, learning speed (efficiency) and educational effectiveness.

The cited prior art document U.S. Pat. No. 7,454,386B2 discloses a learning management system including a content storage unit for storing learning content, a user modeling unit in signal communication with the content storage unit and having a user model, a personalization unit in signal communication with the content storage unit for personalizing the learning content stored in the content storage unit in response to the user model, and a user interface in signal communication with the content storage unit for enabling a user to interact with the learning management system, wherein the learning management system delivers content responsive to user interaction with the learning management system. However, the cited prior art document only enlists about the process of adaptive learning and does not disclose about solving a mathematical or any problem related to a subject entered by a user. Further in the cited prior art document personalizing the content in terms of pace and content is not possible as it relates to pre-recorded/pre-stored content.

Therefore, keeping in view of the problems associated with the state of the art, there is a need for learning system that provides truly specialized, customized, personalized, or content specific problem solving to the user.

### Objectives of the Invention

The primary objective of the present invention is to provide a specialized and customized automated learning system.

Yet another objective of the present invention is to provide a hyper-personalized learning system utilizing artificial intelligence, proprietary machine learning algorithms and components of optical character recognition and text to speech.

Yet another objective of the present invention is to provide an audio-visual aided learning module and material.

Another objective of the present invention is to provide a system that facilitates interaction between a user and the learning system.

Yet another objective of the present invention is to provide learning system embodied either in any communication device or in any handheld playback device with a display unit.

Yet another objective of the present invention is to provide a learning system which not only helps the user to solve mathematics related problems, but also to make them proficient in providing analytical solution to such problems.

Other objectives and advantages of the present invention will become apparent from the following description taken in connection with the accompanying drawings, wherein, by way of illustration and example, the aspects of the present invention are disclosed.

### BRIEF DESCRIPTION OF DRAWINGS

The present invention will be better understood after reading the following detailed description of the presently preferred aspects thereof with reference to the appended drawings, in which the features, other aspects and advantages of certain exemplary embodiments of the invention will be more apparent from the accompanying drawing in which:

FIG. 1a and FIG. 1b illustrate the basic components of the hyper-personalized learning system;

FIG. 2 illustrates a user's interaction with learning system;

FIG. 3a and FIG. 3b illustrate an overview of the Explainer module;

FIG. 4a and FIG. 4b illustrate user's interaction with the Explainer module;

FIG. 5a and FIG. 5b illustrate student interaction after viewing an audio-visual explanation;

FIG. 6a and FIG. 6b illustrate the assessment module

### SUMMARY OF THE INVENTION

The present invention relates to a method and system that facilitates online education system providing specialized, customized, or content specific problem solving. The system further facilitates a complete learning application with three integrated components—learning, assessment and revision, each component being hyper-personalized to the finest level. The hyper-personalized learning system is designed using proprietary machine learning algorithms and components of optical character recognition and text to speech. Further, at least three components of the integrated learning system not only learns about a student's current proficiency level through student's interactions with itself, but also utilize the learning from other components. This improves effectiveness of each component, no matter which component is being used by a student.

The learning component is hyper-personalized so that it can explain solution to any problem posed to it and can adjust the pace and content of the explanation to a level which is comfortable for a student to grasp/understand. The assessment component is also hyper-personalized so that it starts off with problems at a level of difficulty which is comfortable for a student to solve. The student is then gradually challenged with more difficult problems. The hyper-personalized revision module is used by a student closer to a test or examination and allows the student to specify what kind of problems they want to revise. The learning system works as a personal tutor for a student, anytime they want and for as long as they want. The learning system is available as an application (app) which can be used on any communication device.

### DETAILED DESCRIPTION OF INVENTION

The following detailed description and embodiments set forth herein below are merely exemplary out of the wide variety and arrangement of instructions which can be employed with the present invention. The present invention may be embodied in other specific forms without departing from the spirit or essential characteristics thereof. All the features disclosed in this specification may be replaced by similar other or alternative features performing similar or same or equivalent purposes. Thus, unless expressly stated otherwise, they all are within the scope of the present invention.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms and words used in the following description and claims are not limited to the bibliographical meanings but are merely used to enable a clear and consistent understanding of the invention. Accordingly, it should be apparent to those skilled in the art that the following description of exemplary embodiments of the present invention are provided for illustration purpose only and not for the purpose of limiting the invention.

It is to be understood that the singular forms “a”, “an” and “the” include plural referents unless the context clearly dictates otherwise.

It should be emphasized that the term “comprises/comprising” when used in this specification is taken to specify the presence of stated features, integers, steps or components but does not preclude the presence or addition of one or more other features, integers, steps, components or groups thereof.

It should further be noted that any reference signs do not limit the scope of the claims, that the example embodiments may be implemented at least in part by means of a hardware, and that several “means”, “units” or “devices” may be represented by the same item of hardware.

In accordance with the present invention the learning system is completely automated and integrates all aspects of learning. The learning system of the present invention is based on adaptive educational hypermedia systems.

In an exemplary embodiment of the present invention the learning system is available to school or college school students to improve their proficiency in the subject of mathematics and related subjects. It has been observed that school or college students learn their basic concepts and formulae of mathematics in class, but when it comes to solving story sums or word problems described in English (or any other language for that matter), the students are not able to map the English description of a problem to the mathematics concepts they have learnt. Whereas the learning system described herein puts solving the word problems at its core and develops a complete learning system around this core concept.

In an exemplary embodiment of the present invention, the learning system provides solution to mathematics related problems put forth to it, through artificial intelligence, machine learning, and algorithms to the teacher, student, guardian, or any other user.

In accordance with the present invention, the learning system is any communication device or handheld device, which facilitates downloading and installing of said learning system application. The said handheld device is at least provided with display, camera, microphone, and speaker. The components of the communication device are discussed herein in detail:
(a) Display Unit—The display unit provides visual representation of the learning system. The display unit may be a touch screen display and utilized for receiving input from the user to the various queries, questions etc. being displayed on the display unit. The display device may include but not limited to liquid crystal display, light-emitting diode, organic light-emitting diode, thin film transistor, plasma display etc. The visual representation may be in different forms such as, but not limited to, audio, video, image, graphics, text, hologram, or a combination thereof.
(b) Image Capturing Unit/Camera—The communication device comprises at least one camera for capturing images. The camera may be of different types, sizes, configurations, and functionalities. The camera is utilized to capture the input from the user.
(c) Processing Unit—It is a central unit of the system for acquiring, assessing, and implementing all the decisions related to the system. The processing unit may be, but not limited to, processors, central processing unit, graphical processing unit, microcontrollers, or a combination thereof.
(d) Storage Unit: The storage unit comprises one or more non-volatile memory which can be of different types, shapes, sizes, dimensions, and configurations. The storage unit includes artificial intelligence and machine learning algorithms to be loaded, run, executed, processed etc. by the processing unit as per the requirement.
(e) I/O Ports: The ports facilitate the connection of peripherals to the computation device, both to communicate with and to supply electric power.
(f) Networking unit: The networking unit includes wireless connections for receiving data from or transferring data to processing unit or other electronic devices. This unit is used to connect the device to the internet.
(g) Software Module: The software module is an artificial intelligence module configured in the processing device for acquiring, analyzing, and representing the data related to the learning system. The software module utilizes machine learning algorithms for analyzing and assessing the data related to the learning system.
(h) Microphone: The microphone is utilized by the user for interacting/verbal communication with the learning system. For example, for asking questions or replying to any particular query etc.
(i) Speaker: The speaker is utilized by the user for hearing the content displayed on the display unit if required or for audio enhancement.

In accordance with the present invention, the learning system uses Artificial Intelligence and machine learning algorithms to automatically generate an audio-visual explanation to the problem presented to it. Since an audio-visual explanation is generated on the fly, it can be completely hyper-personalized for pace and content for every learner. The hyper-personalization is governed by various parameters that the system learns about a particular person as the person interacts with the system. The implementation of the invention is available on any communication device to students. The software module of the present invention includes the following components:
a. Learning Module—An integrated module for learning including learning basic concepts, doubt/problem solving, assessment and revision. Hyper-personalize each aspect to ensure every student is able to understand and develop proficiency in mathematics and related subjects.
b. Problem Solving Module—Any person may ask any mathematics related question and in response, an audio-visual explanation will be generated. In an exemplary embodiment, a student may ask a question by pointing device camera to the problem in a book/paper, by narrating the problem using the application, or by entering the problem in textual form using the device keyboard.
c. Content Replay Module: Any person may ask for replay of the explanation with different variations—make it easier, replay at the same level of explanation, or go a bit faster. This allows each explanation to be hyper-personalized for pace and content such that the student finds it comfortable to grasp the explanation and relevant concepts.
d. Assessment Module: Anyone can do practice through the assessment module. The assessment module hyper-personalizes the progression of questions asked. It starts with questions at a level of difficulty which is comfortable for the person to solve and challenges the person by gradually increasing the level of difficulty of the questions asked. The assessment module presents a hint if asked for. Further, if the person is not able to solve the question, the assessment module explains the solution.
e. Assessment Hyper-personalization Module: The assessment module not only checks the final answer but also checks intermediate steps to solve a problem. This allows it to collect better parameters for hyper-personalization.
f. Revision Module: In an exemplary embodiment the revision module is used by a student closer to a test or examination. The revision module is hyper-personalized, and a person can select the kind of problems she/he wants to revise. In an exemplary embodiment of the present invention some of the possible choices are:
   i. Revise the problems for which the user asked for repeated replays during explanation;
   ii. Revise the problems which the user could not solve during assessment;
   iii. Revise the problems for which the user asked for hint;
   iv. Revise the problems which need conversion of units;

In accordance with the present invention at least all the three modules, explainer/problem solver, assessment, and revision, are integrated such that each module uses parameters learned during user interaction with other modules for it's own hyper-personalization.

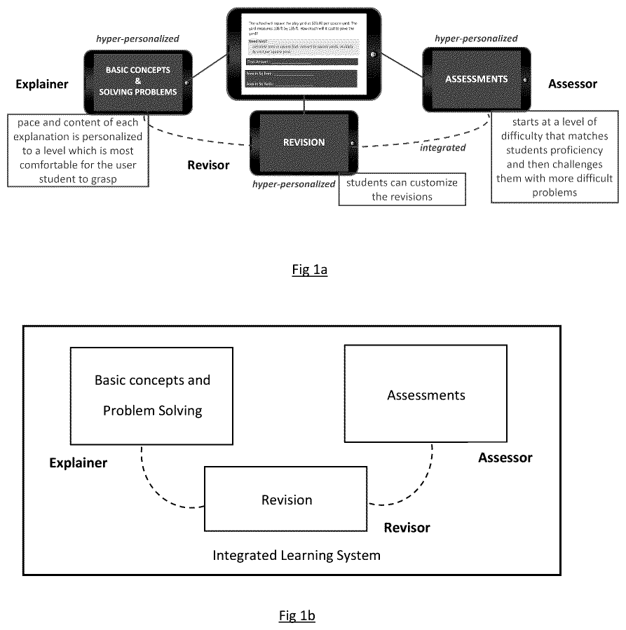

In an exemplary embodiment of the present invention hyper-personalized learning system includes at least three basic components as illustrated in FIG. 1a and FIG. 1b. The three basic components have following characteristics:

(a) Explainer Module—Basic Concepts Learning and Problem-Solving Module
a. Every user has different grasping level. The system personalizes pace and content to a level that is comfortable to grasp.
b. A user needs an explanation that she/he can understand.
c. A pre-recorded explanation cannot be personalized for every user.
d. A set of pre-recorded explanations cannot explain solution to every problem.

(b) Assessor—Assessments/Practice Module
a. Must begin assessment at right level of difficulty and then challenge the students further
b. Cannot randomly provide problems to students

(c) Revisor—Revision Module

A user must be able to specify what they want to revise

In accordance with the present invention main goal of the learning system is not only to help users solve mathematics related problems, but also to make them proficient in providing analytical solution to such problems.

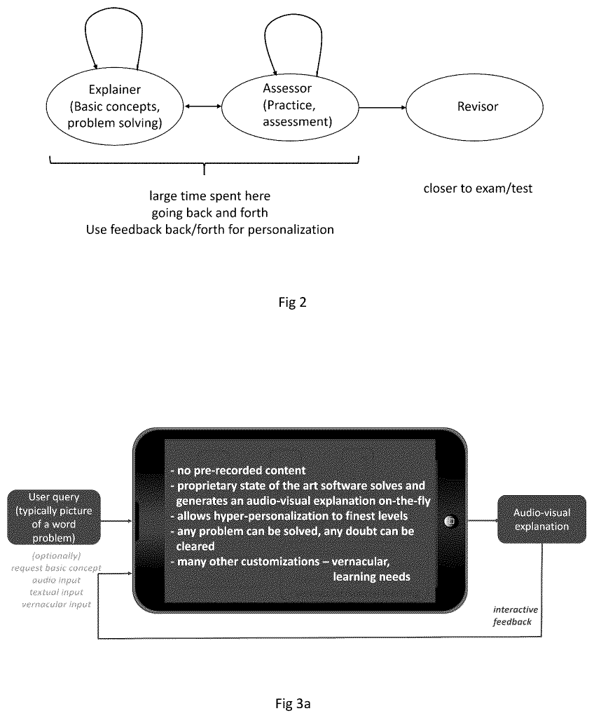

In accordance with the present invention a user's typical interaction with the learning system is illustrated in FIG. 2. A user typically starts with the Explainer module for learning of basic concepts and learning how to solve problems. The student will spend some time with the Explainer module and then go to Assessor module for practice and assessment. The user can go back and forth between the Explainer and Assessor modules for better learning of the concepts. A large time is typically spent by a student between these two modules. The student will use the Revisor module for revisions close to a test or examination.

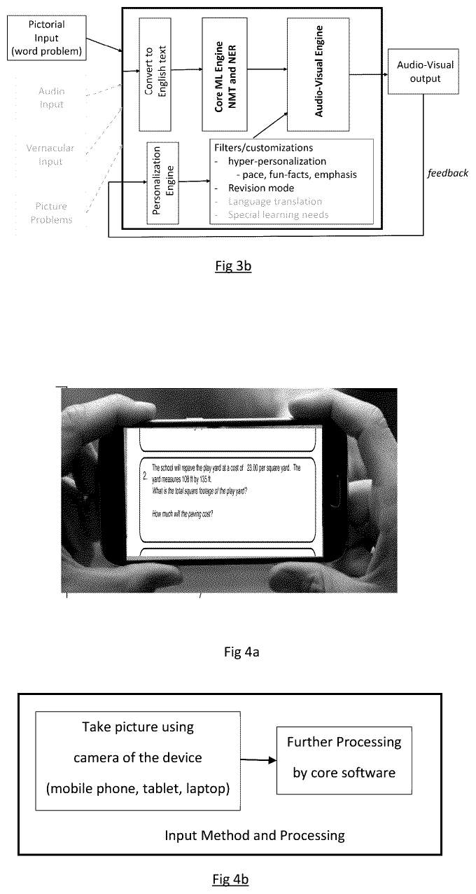

In accordance with the present invention the Explainer module is the most important and core module of this learning system. An overview of the Explainer module is illustrated in FIG. 3a and FIG. 3b. A user interaction with the Explainer module begins by specifying a question or by asking to refresh the basic concepts. A question is typically specified by pointing the camera of the device at the problem in a book or a question paper. Alternately a student can either state the problem using voice command or enter it in textual format using device keyboard. If a student asks for refresh of basic concepts, the application selects problems on its own. Once the problem has been specified by user or selected by application itself, as a next step an audio-visual explanation is generated and presented on the screen of the device. Since the audio-visual explanation is generated on the fly, this learning system can solve any problem and each explanation can be hyper-personalized. The fact that an explanation is generated on-the-fly also allows other customizations, for example generating explanation in vernacular languages or generating explanations for students with special learning needs.

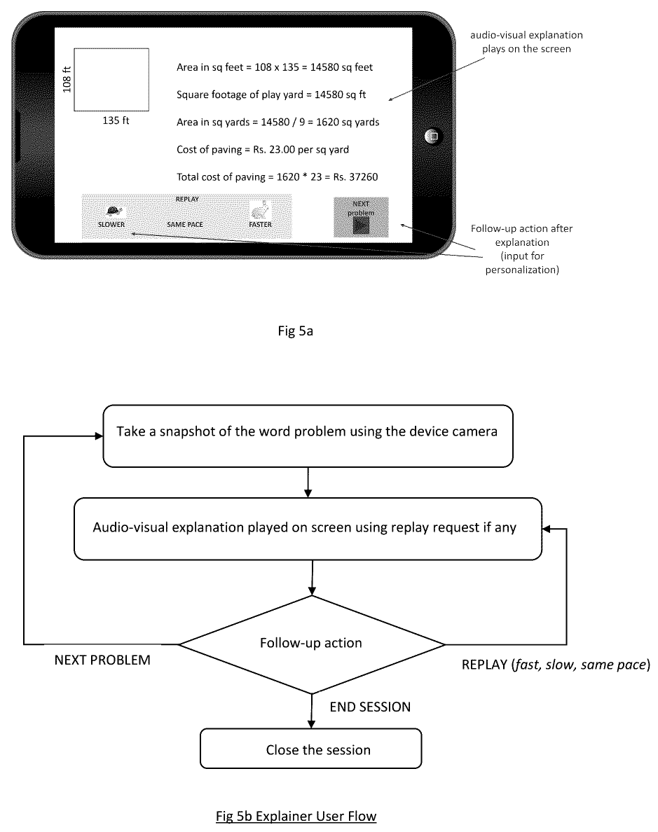

In accordance with the present invention FIG. 4a and FIG. 4b illustrate another depiction of user's interaction with the Explainer module. After presenting the explanation to the user, the student interacts with the system. These interactions allow the system to determine parameters for hyper-personalization of the explanations.

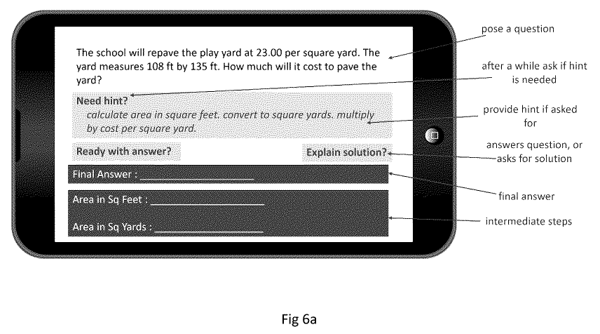

In accordance with the present invention FIG. 5a and FIG. 5b illustrate the way a student interacts with the system after an audio-visual explanation has been played on the screen. A student can request the system for any one of the following actions:
a. Replay the solution at a slower pace or in an easier manner
b. Replay the solution at the same pace
c. Replay the solution at a faster pace
d. Go to the next problem

These choices provide control to the student and allows the learning system to arrive at hyper-personalized explanations suitable to that particular student.

In accordance with the present invention replaying a solution at a slower pace does not imply just re-playing a video at a slower speed. The learning system uses methods of scaffolding and handholding to modify pace and content such that the explanation gets easier. These techniques are:
a. Emphasize key concepts and formulae
b. Repeat a few key concepts multiple times
c. Explain same concepts in multiple different ways
d. Spend time on basic concepts even of previous chapter or previous class
e. Take a small pause after explaining a step to allow the student to absorb the concept
f. Spend more time on pictorial explanations
g. Do micro-assessment by asking quick short questions during explanations

These choices provide control to the student and allows the learning system to arrive at hyper-personalized explanations suitable to that particular student.

In accordance with the present invention the hyper-personalization techniques used are classified as follows:

1) Default Hyper-Personalization Techniques

The default hyper-personalization techniques are used by the learning system without learning any parameters from user interactions. These are,
i. Even if replay is requested at the same pace, modify it a little bit so that it feels like a different explanation of the same problem
ii. Explain tips and tricks for quick calculations at regular intervals or whenever there is an opportunity during an explanation
iii. When a new chapter is started, always include details of the basic concepts for the first few explanations
iv. For the first few explanations, include fun facts. For example, while explaining solution to a problem on perimeter, include fun fact about length of the coastal line of India or coastal line of USA

2) Interaction-Based Hyper-Personalization Techniques

These hyper-personalization techniques are derived from student's interactions with the learning system. These are,
i. Adjust pace of replay as per current request (slow/go easy, same pace, or go faster)
ii. Adjust default pace and content as per past few requests. Repeated requests for going easy implies the default pace and content should be made easier. Similarly, repeated requests to go faster implies default pace and content can be made faster.
iii. Repeated replays at same speed implies slow down, so go easy even after a few requests for replay at the same speed
iv. Adjust pace and content as per interactions during assessment session. Learning from a student's interactions during assessment can be used during explanation as well. Though the Assessor component is explained in the next section, some of the examples are explained here. This is the advantage of an integrated system where learnings from one component are used in another component. Some examples are,
   1. Repeated need of hints for solving problems implies going easier in the explanations.
   2. Time taken to solve an assessment problem is used to determine student's proficiency level and adjust the pace of explanation. If student is taking more time, than the explanations can be made to go easier.
   3. Mistakes in intermediate steps indicate aspects which need to be emphasized during explanation. For example, if a student is making mistakes in unit conversion, then it implies that explanation can emphasize more on unit conversion steps.

In accordance with the present invention the Explainer module is the core module of the learning system. We have described various features of the Explainer module so far. We now explain the technical details of the machine learning algorithm used to generate an explanation of any problem on-the-fly and the manner in which hyper-personalization is done.

In accordance with the present invention the block diagram of the explanation generation in the Explainer module is illustrated in FIG. 3b. In an exemplary embodiment of the present invention a student using the learning system specifies a problem to be solved through a picture of the word problem. Alternative ways of specifying the problem to the system are audio input (speak the problem) and text input (type in the text of the problem). The input specification may as well be in a vernacular language and also a mix of text and pictures. A problem specified in any of the possible ways is first converted to problem text in English language. Optical character recognition and speech-to-text components are used to get the problem text in English language. The core machine learning engine that we have developed works on a problem text specified using English language. The machine learning engine combines neural machine translation (NMT) and named entity recognition (NER) techniques. The machine learning engine does not directly generate the final audio-visual explanation. The output of the machine learning engine is in textual form. An Audio-Visual Engine component generates text and pictures of the solution which are played on the screen as video of the explanation. This component also generates a script of the solution which is passed through a text-to-speech component to generate the audio of the explanation and synchronizes the audio with the video content. The Audio-Visual Engine component uses one or more filters to hyper-personalize the content. These filters are derived from a personalization engine. The personalization engine infers the filters based on the interactions that the student has with the system. The Assessor assessment and practice module is used by a student for practice and assessing their own proficiency level. In addition to this explicit assessment module, micro-assessments are built in during in the Explainer module itself. The micro-assessments are quick questions asked during explanations itself and help in keeping the student engaged during explanations.

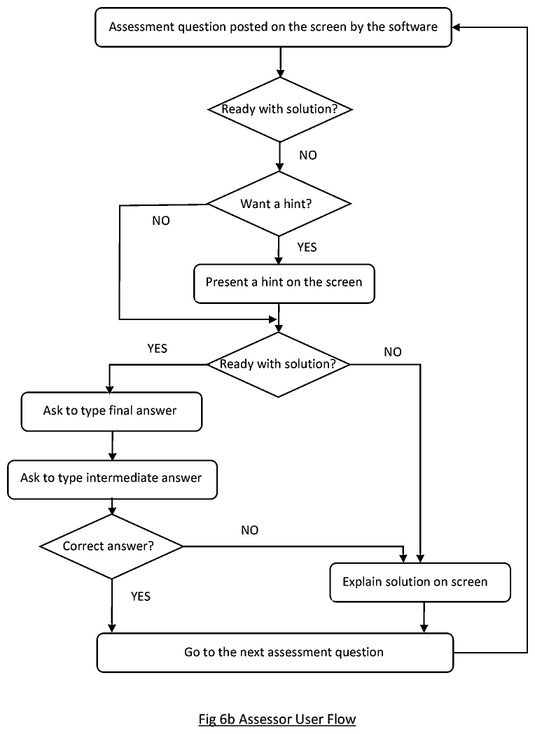

In accordance with the present invention the assessment module can be described with the help of FIG. 6a and FIG. 6b. The module poses a question for the student to solve. The student solves the problem in a notebook or on a paper. After a brief while the module enquires whether a student needs a hint to solve the problem. If the student says that they need a hint, a hint is presented, otherwise the student is left to himself/herself to solve the question. The student might be ready with an answer after a while or might give up and ask for explanation of the solution. If user asks for explanation of the solution, the solution is explained in a manner described in the section on Explainer module. If the user is ready with the answer, he/she is asked to enter the final answer, as well as answers to some of the important intermediate steps.

In accordance with the present invention at some point of time in future, the Assessor module will evaluate the final answer and intermediate steps by pointing device camera to the solution on paper that the student has worked out.

In accordance with the present invention as a student starts using the Assessor module, it uses the parameters derived during interactions in Explainer module for personalization. As a student spends more time on Assessor module, more parameters are derived for better personalization. The purpose of hyper-personalization during assessment is to start assessment at a level of difficulty which is comfortable for the student and then gradually increase the level of difficulty. The assessment personalization parameters and their interpretations are explained in the following.
a. Feedback from Explainer—requests for replays and requests for easier explanations or requests for faster explanations are used to arrive at a level of difficulty to start with.
b. Student not asking for hints, providing correct answers, solving in quick time, and correct answer to intermediate steps imply that the questions are easy for the student—this implies that the level of difficulty must be increased.
c. Student asking for hints, providing correct answers in reasonable time and correct intermediate steps imply that the level of difficulty is just about right for the student—this implies that this level of difficulty must be maintained.
d. Student asking for hints, not able to get correct answers and/or mistakes in intermediate steps imply that the questions are difficult for the student—this implies that the level of difficulty must be decreased.
e. Other factors—for example, mistakes in intermediate steps of unit conversion imply that more questions involving unit conversion must be posed.

The assessment module starts with asking questions at a level of difficulty which is comfortable for a student and then gradually challenges the student with more and more difficult assessment questions. Further, many of the interactions in the assessment module are used for hyper-personalization of the Explainer module as well, as a student moves between the Assessor and the Explainer modules.

3) Revisor—Revision

The Revisor for revision module is used by a student closer to a test or examination. This module is used for quick refresh of key concepts of specific topics. The revision refresher is presented as a short and quick audio-visual explanation, outlining the key concepts and steps to solve a problem. A student has multiple options of personalizing the problems that they want to revise.
a. Get a quick explanation of the problem pointed at by the device camera
b. Go over all the problems used in Explainer sessions earlier
c. Go over only the problems for which the student asked for hints during assessment sessions
d. Go over all the problems that the student could not solve during assessment sessions
e. Randomly select problems

While this invention has been described in connection with what is presently considered to be the most practical and preferred embodiment, it is to be understood that the invention is not limited to the disclosed embodiments, but, on the contrary, is intended to cover various modifications and equivalent arrangements included within the scope of the appended claims.

We claim:

1. A hyper-personalized interactive learning system comprising:
a communication device, comprising:
a display unit for displaying the contents of a learning system;
a plurality of Input device including:
an image capturing unit configured to capture input from the user
in the form of personalized questions;
a microphone configured to provide audio input from the user;
a plurality of I/O Ports providing connection between peripheral and communication device;
a storage unit comprising of a plurality of non-volatile memory for storing machine learning and AI algorithms;
a processing unit for analyzing the
a personalized questions provided by the user: the processing unit comprising a software module for acquiring, analyzing, and representing the data related to the learning system, said software module comprising:
a learning module for hyper-personalized learning:
a problem solving module configured to generate an audio-visual explanation in response to the personalized questions provided by the user said audio-visual explanation is generated and the system is not merely playing a pre-recorded video:
a content replay module to replay an explanation generated by the problem solving module, characterized in that each of such explanation generated is hyper-personalized for pace and content based on the request and comfort of the user:
an assessment module for analysing the progression of learning by the user, starting with an input of lower difficulty to gradually progress to the input of higher level of difficulty, characterized in that the assessment hyper-personalization module checks a conclusion and corresponding intermediate steps involved in arriving at the conclusion for the input by the user; and
a revision module for revising the explanations sought by the user seeking repetition of explanation generated by the problem solving module:
a networking unit for transferring and receiving data on the internet between a plurality of communication devices of different users; and
a speaker for output from the learning system.

2. The system as claimed in claim 1, wherein the system is a hand held device.

3. A method for providing hyper-personalized interactive learning comprising the steps of:
providing input through the input device to specify a question or to refresh the basic concepts by a user to provide any one of the following to the user:
to provide conceptual knowledge to user through a learning module;
to generate and provide solution including audio-visual explanation to any analytical problem of the user through a problem solving module; and
displaying audio visual explanation of the solution to the inputs provided by the user:
providing inputs through the input device by a user for entering a request to replay personalized explanation by the content replay module selected from:
a slow pace replay;
a fast pace replay;
same pace replay; or
moving to next question:
configuring audio-visual explanation for pace and content based on user request and replaying the configured solution;
assessing the knowledge of the user through an assessment module configured to provide personalized questions based on comfort level of the user;
checking the sequential steps utilized by the user in solving a problem by an assessment hyper-personalization module; and
providing personalized assistance in revision of the required subject matter to the user through a revision module.

4. The method as claimed in claim 3, wherein the hyper-personalized interactive learning comprises the following steps:
switching on the hyper-personalized interactive learning system;
specifying the problem to be solved through input module; and
providing personalized audio-visual solution to the problem specified by the user through problem solving module.

5. The method as claimed in claim 3, wherein the working of input comprises the following steps:
capturing the problem specified by the user through camera of the hand held device;
transferring the image to processing device; and
assessing the image for providing solution.

6. The method as claimed in claim 3, wherein the problem solving comprises the following steps:
capturing the snapshot of the problem specified by the user through camera of the hand held device;
displaying generated audio-visual explanation on the screen;
receiving input from user regarding personalization for replaying the solution;
replaying personalized content as requested by user and establishing proficiency level of user based on the requests; and
providing/specifying another problem by the user to be solved through the camera of hand held device.

7. The method as claimed in claim 4, wherein assessment comprises the following steps:
displaying a personalized problem to the user;
providing hint to solve the problem based on the user's requirement;
assessing the final solution and intermittent steps provided by the user as correct or incorrect;
displaying the solution of the problem provided to the user with the explanation, in case solution provided by user is incorrect or user requests displaying of the solution;
establishing proficiency level of user based on interactions;
personalizing level of difficulty of next problems based on that; and
providing next problem to be solved by the user.
